(19) United States
(12) Patent Application Publication
(10) Pub. No.: US 2026/0014692 A1
(43) Pub. Date: Jan. 15, 2026

(54) TOOLBOX SYSTEM

(71) Applicant: Nanjing Chervon Industry Co., Ltd., Nanjing (CN)

(72) Inventor: Cheng Chen, Nanjing (CN)

(21) Appl. No.: 19/331,704

(22) Filed: Sep. 17, 2025

Related U.S. Application Data
(63) Continuation of application No. PCT/CN2024/088160, filed on Apr. 17, 2024.

(30) Foreign Application Priority Data
Apr. 20, 2023 (CN) 202310437577.8

(51) Int. Cl. B25H 3/02

(52) U.S. Cl. CPC B25H 3/026; B25H 3/028

(57) ABSTRACT

A toolbox system includes a first type of storage box including a box body formed with an accommodation cavity for storing an item. The toolbox system further includes a second type of storage box for storing the item; and at least one interlocking assembly, where the second type of storage box is connected to the first type of storage box through the at least one interlocking assembly. The first type of storage box further includes a traveling assembly connected to the box body and including at least one wheel; an opening capable of being opened to expose the accommodation cavity; and at least one first connector capable of mating with the opening to keep the opening in an open state or a closed state. The opening is disposed on a sidewall of the box body.

This application is a continuation of International Application Number PCT/CN2024/088160, filed on Apr. 17, 2024, through which this application also claims the benefit under 35 U.S.C. § 119 (a) of Chinese Patent Application No. CN 202310437577.8, filed on Apr. 20, 2023, which applications are incorporated herein by reference in their entireties.

### BACKGROUND

When the user goes to the workplace to work, the user generally needs to carry items to be used. To facilitate carrying and transporting the preceding tools, the user generally uses the storage box to store the preceding items. For example, a tool, a charger, a battery pack, a tool accessory, and the like may all be placed in the storage box. The storage box is connected to a traveling assembly so that it is convenient for the user to move the storage box. To allow the user to transport more tools, other items, such as storage boxes, may be placed on top of the storage box. However, when accessing the items in the bottom storage box, the user needs to move the upper items away before opening the lower storage box to access or store items, causing inconvenience for the user.

### SUMMARY

To solve the deficiencies in the existing art, an object of the present application is to provide a toolbox system through which the user can easily take out or store items.

To achieve the preceding object, the present application adopts the technical solutions below. A toolbox system includes a first type of storage box including a box body formed with an accommodation cavity for storing an item. The toolbox system further includes a second type of storage box for storing the item; and at least one interlocking assembly, where the second type of storage box is connected to the first type of storage box through the at least one interlocking assembly. The first type of storage box further includes a traveling assembly connected to the box body and including at least one wheel; an opening capable of being opened to expose the accommodation cavity; and at least one first connector capable of mating with the opening to keep the opening in an open state or a closed state. The opening is disposed on a sidewall of the box body.

In some examples, the toolbox system further includes a third type of storage box for storing the item; the first type of storage box includes an upper top wall and a lower bottom wall that are opposite to each other, two interlocking assemblies are disposed on the upper top wall, and the second type of storage box and the third type of storage box are capable of being connected to the first type of storage box side by side through the two interlocking assemblies.

In some examples, the first type of storage box includes the upper top wall and the lower bottom wall that are opposite to each other, and along an up and down direction, the distance L1 from the upper top wall to the lower bottom wall is less than or equal to 450 mm.

In some examples, the first type of storage box is provided with an abutment portion, at least part of the abutment portion and at least part of the at least one wheel are capable of being in contact with the ground at the same time, at least three contact points exist when the at least one wheel and the abutment portion are in contact with the ground, and a plane where the at least three contact points are located is defined as a support plane P; and when the at least one wheel and the abutment portion are in contact with the ground, a first connection line L2 between the center of gravity G of the first type of storage box and the ground is basically perpendicular to the support plane P.

In some examples, the first type of storage box is provided with connection sections; the toolbox system further includes an external hanger assembly, the external hanger assembly includes an intermediate piece and an external hanger, and the intermediate piece is connectable to a connection section of the connection sections through one or a combination of screws, pins, rivets, and movable buckles; and the external hanger is connectable to the intermediate piece and/or the connection section through one or a combination of screws, pins, rivets, and movable buckles.

In some examples, the toolbox system further includes an external hanger for detachably connecting the item; and a mounting portion is formed on a sidewall of the box body, and the external hanger is connectable to the mounting portion through one or a combination of screws, pins, rivets, adsorption, and movable buckles.

In some examples, the box body includes a front sidewall, a rear sidewall, a left sidewall, a right sidewall, a lower bottom wall, and an upper top wall, where each of the front sidewall, the rear sidewall, the left sidewall, and the right sidewall extends basically along an up and down direction, and the lower bottom wall and the upper top wall are opposite to each other and basically enclose the front sidewall, the rear sidewall, the left sidewall, and the right sidewall; at least one track assembly is disposed in the accommodation cavity, each of the at least one track assembly is provided with an adaptive first connector of the at least one first connector, and the at least one first connector is slidably connected to the box body through the at least one track assembly.

In some examples, the toolbox system further includes a handle assembly, the handle assembly has a grip, the grip and the at least one wheel are disposed at two ends of the box body, and the at least one first connector is disposed on a sidewall between the grip and the box body.

In some examples, the toolbox system further includes a handle assembly, the handle assembly has a grip, the grip and the at least one wheel are disposed on the same side of the box body, and the at least one first connector is disposed on a sidewall opposite to the at least one wheel.

In some examples, the first type of storage box includes at least two correspondingly arranged track assemblies, each of the at least two track assemblies includes a first guide member and a second guide member that mate with each other, the first guide member is connected to the box body, the second guide member is connected to a first connector of the at least one first connector, the second guide member is partially engaged in the first guide member, and the second guide member is configured to slide relative to the first guide member.

In some examples, the box body includes a front sidewall, a rear sidewall, a left sidewall, a right sidewall, a lower bottom wall, and an upper top wall, where each of the front sidewall, the rear sidewall, the left sidewall, and the right sidewall extends basically along an up and down direction, and the lower bottom wall and the upper top wall are opposite to each other and basically enclose the front sidewall, the rear sidewall, the left sidewall, and the right sidewall; at least one track assembly is disposed in the accommodation cavity, each of the at least one track assembly is provided with an adaptive first connector of the at least one first connector, and the at least one first connector is rotatably connected to the box body through the at least one track assembly.

In some examples, the toolbox system further includes a locking plate and a coupling member; and two hollow protrusions are formed on the front sidewall of the first type of storage box and are defined as a first protrusion and a second protrusion, the first protrusion and the second protrusion are disposed on two sides of the opening, the locking plate is capable of passing through the first protrusion and the second protrusion, corresponding locking holes are formed on the locking plate and the first protrusion, and the coupling member is capable of passing through the locking holes to connect the locking plate to the first protrusion.

In some examples, the traveling assembly includes four wheels connected to four sides of the box body; and the first type of storage box further includes a handle assembly connected to the box body, the handle assembly includes a first handle, and the first handle is pushed and pulled so that the four wheels are movable relative to the ground, and the first type of storage box and the second type of storage box are movable together.

In some examples, the first type of storage box is further provided with a driving device for driving the traveling assembly to move or stop.

A toolbox system includes a first type of storage box including a box body formed with an accommodation cavity for storing an item. The first type of storage box further includes a traveling assembly connected to the box body and including at least one wheel; an opening capable of being opened to expose the accommodation cavity; and at least one first connector capable of mating with the opening to keep the opening in an open state or a closed state. The opening is disposed on a sidewall of the box body.

A toolbox includes a first type of storage box including a box body formed with an accommodation cavity for storing an item. The toolbox system further includes a second type of storage box for storing the item; and at least one interlocking assembly configured to mount the second type of storage box to an upper side of the first type of storage box. The first type of storage box further includes a traveling assembly connected to the box body and configured to drive the box body to move; and an opening disposed on the box body, where when the second type of storage box is connected to the first type of storage box, the opening is configured to be opened to expose the accommodation cavity.

In some examples, the box body includes a front sidewall, a rear sidewall, a left sidewall, a right sidewall, a lower bottom wall, and an upper top wall, where each of the front sidewall, the rear sidewall, the left sidewall, and the right sidewall extends basically along an up and down direction, and the lower bottom wall and the upper top wall are opposite to each other and basically enclose the front sidewall, the rear sidewall, the left sidewall, and the right sidewall; and the opening is disposed at a lower end of the upper top wall.

In some examples, the traveling assembly includes wheels connected to the rear sidewall of the box body, the first type of storage box has a distance in a length direction, and when the distance is less than or equal to 700 mm, the opening is disposed on the front sidewall.

In some examples, the traveling assembly includes wheels connected to the right sidewall of the box body, the first type of storage box has a distance in a length direction, and when the distance is greater than 700 mm, the opening is disposed on the front sidewall.

In some examples, the first type of storage box further includes one or more first connectors, each of which is formed with a recess so that the one or more first connectors avoid the wheels when moving relative to the box body.

In some examples, the first type of storage box further includes track assemblies that mate with the one or more first connectors, and the one or more first connectors are slidably connected to the box body through the track assemblies.

In some examples, the first type of storage box further includes track assemblies, and the one or more first connectors are rotatably connected to the box body through the track assemblies.

The present application has the benefits below. The opening is disposed on the sidewall of the box body of the first type of storage box and is opened or closed through the first connectors so that the user can easily store items in the accommodation cavity or take items out of the accommodation cavity.

### BRIEF DESCRIPTION OF THE DRAWINGS

FIG. 1 is perspective views of a first type of storage box in a toolbox system according to an example.

FIG. 2 is a perspective view of a handle assembly of the first type of storage box in FIG. 1 when the handle assembly is in a second state.

FIG. 3 is a perspective view of a handle assembly of the first type of storage box in FIG. 1 when the handle assembly is in a first state.

FIG. 4 is a perspective view of a first connector in FIG. 1, with the first connector separated from a box body and partially sectioned.

FIG. 5 is a plan view of a first type of storage box in FIG. 4 with a first handle detached.

FIG. 6 is a schematic view of the first type of storage box in FIG. 3 with a locking plate separated from a first connector.

FIG. 7 is a perspective view of a first type of storage box in a toolbox system according to an example.

FIG. 8 is a perspective view of the structure shown in FIG. 7.

FIG. 9 is a perspective view of the structure shown in FIG. 7 from another viewing angle.

FIG. 10 is a plan view of the structure shown in FIG. 7.

FIG. 11 is a perspective view of a first type of storage box in FIG. 7.

FIG. 12 is a schematic view of a first connector in FIG. 10 in an open state.

FIG. 13 is a plan view of the first type of storage box in FIG. 7 that is standing.

FIG. 14 is a schematic view illustrating that a cutting tool cuts a piece to be cut placed on a top wall of the first type of storage box in FIG. 7.

FIG. 15 is a schematic view illustrating that a table cutter is separated from a first type of storage box.

FIG. 16 is a simplified schematic view of a first type of storage box in a toolbox system according to an example.

FIG. 17 is a simplified schematic view of a driving device disposed in a first type of storage box.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom. The present application is described below in detail in conjunction with drawings and examples.

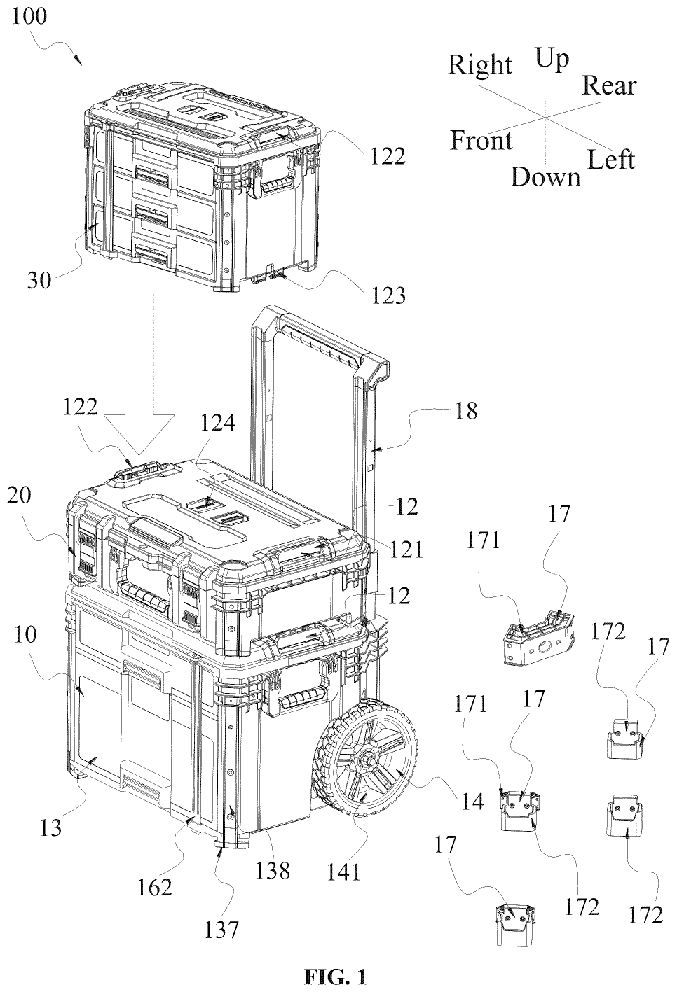

FIG. 1 shows a toolbox system 100 for storing items, such as an accessory, a tool, a charging device, a power supply device, an illumination device, a refrigeration device, a heating device, a blowing device 127, and a storage box. It is to be noted that storing the item as described in the present application not only includes storing the item in a storage box but also includes fixing the item on an outer side of the storage box and keeping the item fixed relative to the storage box, which is also referred to as storing the item in the storage box.

To clearly illustrate the technical solutions of the present application, up, down, front, rear, left, and right as shown in FIG. 1 are defined. It is to be noted that, unless otherwise specified, up and down, front and rear, and left and right are described below with respect to a state where the toolbox system 100 stands still as shown in FIG. 1.

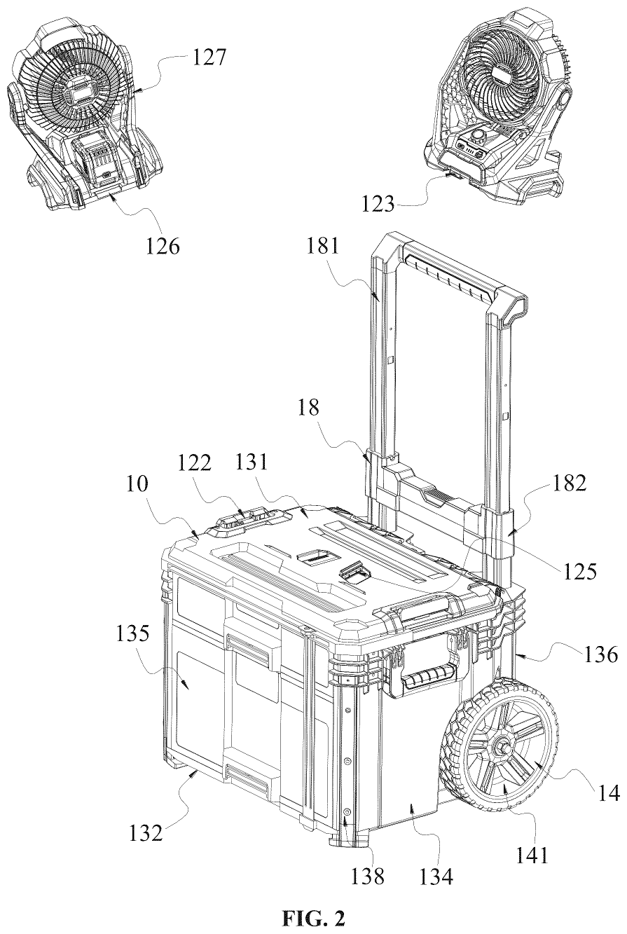

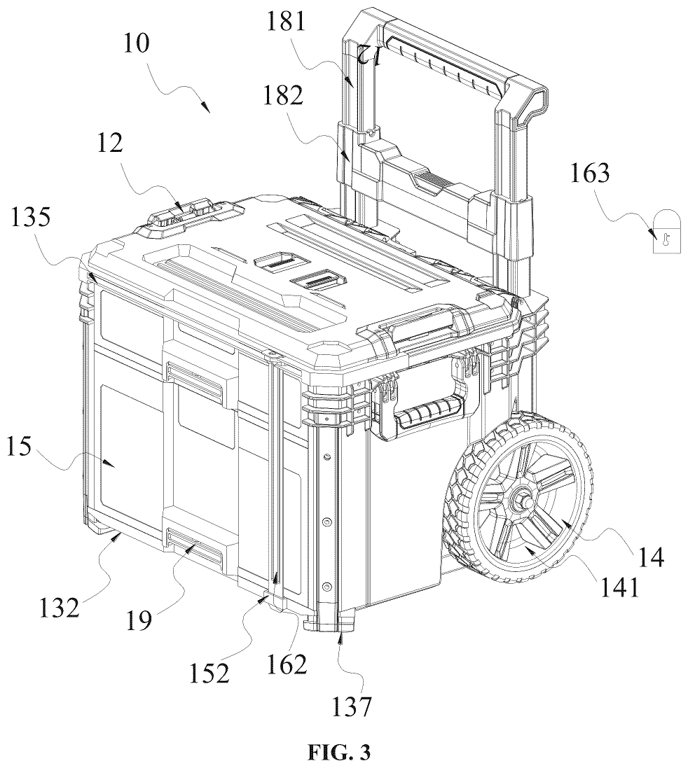

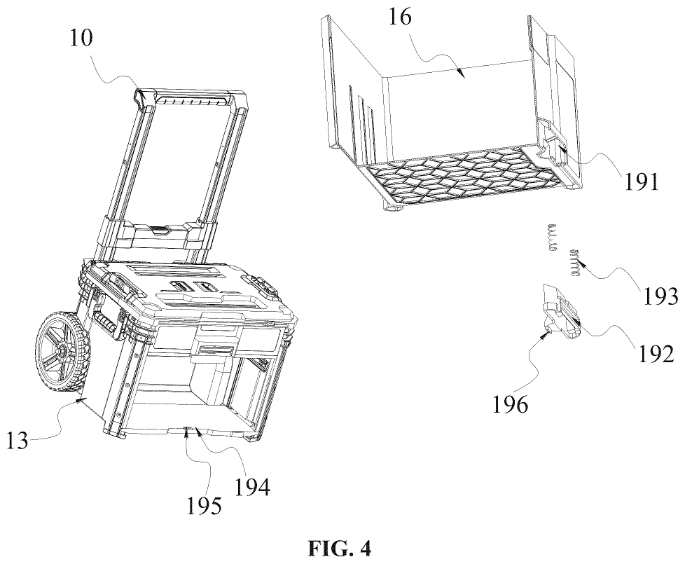

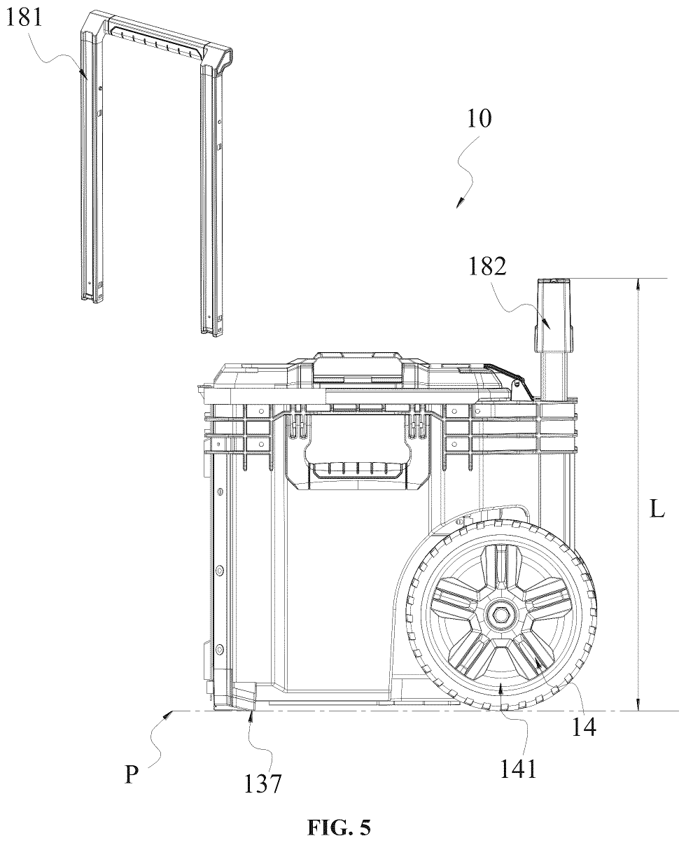

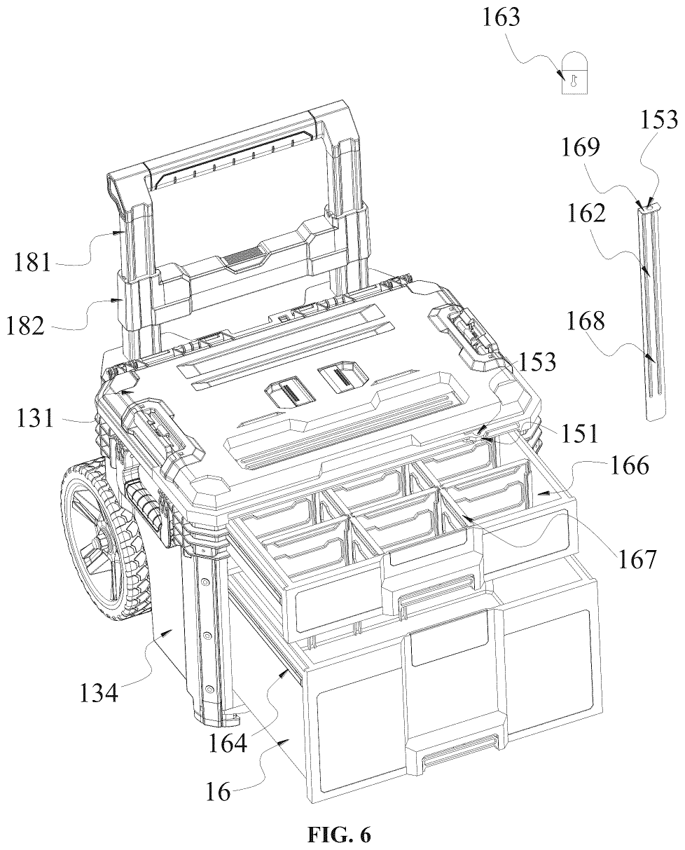

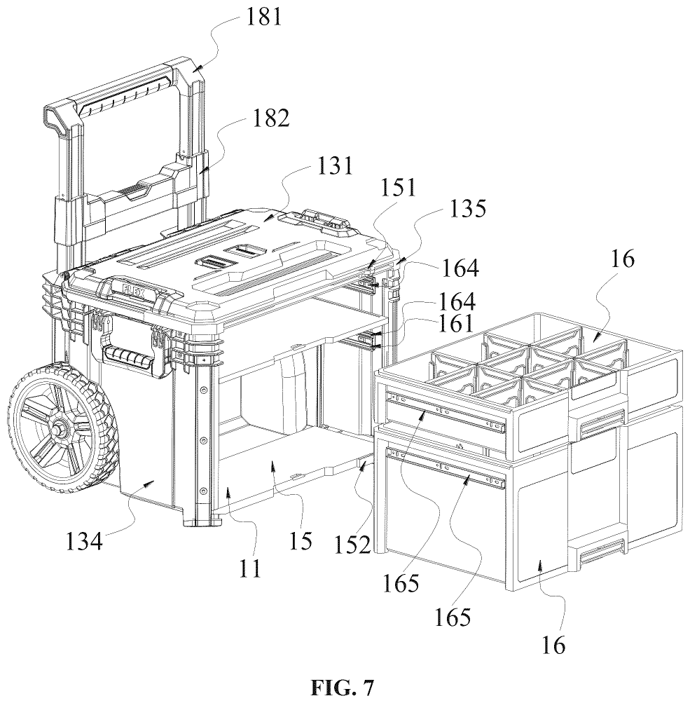

As shown in FIGS. 1 to 7, the toolbox system 100 includes a first type of storage box 10.

The first type of storage box 10 includes a box body 13, a traveling assembly 14, a handle assembly 18, and an interlocking assembly 12. The box body 13 is a main part of the first type of storage box 10. The box body 13 has an accommodation cavity 11 that can store the item. The traveling assembly 14 is connected to the box body 13, includes one or more wheels 141, and can move the box body 13 relative to the ground. The handle assembly 18 is connected to the box body 13. The handle assembly 18 has a first handle 181 for the user to hold. The first handle 181 can move relative to the box body 13, that is, it is to be understood that the first handle 181 can telescope relative to the box body 13. As another example, the first handle 181 can rotate relative to the box body 13. The user can push and pull the first handle 181 so that the wheels 141 can rotate relative to the ground, thereby allowing the box body 13 to move relative to the ground. The interlocking assembly 12 is used for connecting the storage box to the first type of storage box 10 so that the storage boxes can be kept relatively fixed.

In the up and down direction, the box body 13 includes an upper top wall 131 and a lower bottom wall 132 that are opposite to each other. In the left and right direction, the box body 13 includes a left sidewall 133 and a right sidewall 134 that are opposite to each other. In the front and rear direction, the box body 13 includes a front sidewall 135 and a rear sidewall 136 that are opposite to each other. The upper top wall 131, the lower bottom wall 132, the left sidewall 133, the right sidewall 134, the front sidewall 135, and the rear sidewall 136 surround the accommodation cavity 11 for accommodating the item. The left sidewall 133 and the front sidewall 135 are connected via a connection section 138, and the right sidewall 134 and the front sidewall 135 are connected via a connection section 138. An opening 15 is formed on the box body 13 and can be opened to expose the accommodation cavity 11. The opening 15 is disposed at the lower end of the upper top wall 131. Specifically, the first type of storage box 10 further includes a first connector 16 that mates with the opening 15. The first type of storage box 10 includes at least one first connector 16. The first connector 16 can move relative to the box body 13. During the movement of the first connector 16 relative to the box body 13, the opening 15 has an open state and a closed state. When the opening 15 is in the open state, the accommodation cavity 11 is fully exposed. In this case, the user can take out the item in the accommodation cavity 11, and of course, can place the item in the accommodation cavity 11. When the opening 15 is in the closed state, the accommodation cavity 11 is basically completely closed, and the user cannot take out or store the item. As another example, the storage box may not be provided with the upper top wall 131, that is, the storage box is directly opened, and the user can directly take various items out of the accommodation cavity 11 or store various items in the accommodation cavity 11. In the present application, first connectors 16 may have completely consistent structures or completely inconsistent structures.

As an example, the first connector 16 can translate relative to the box body 13. The first type of storage box 10 includes a connection assembly 19 for keeping the first connector 16 and the box body 13 fixed to prevent the first connector 16 from sliding out of the box body 13 without an external force. Especially, the following can be avoided: during some movement processes, the first connector 16 may slide out of the box body 13, causing the item placed in the box body 13 to fall. The first connector 16 has a locked state and an unlocked state. When the first connector 16 is in the locked state, the first connector 16 and the box body 13 remain relatively fixed in the absence of an external driving force. When the first connector 16 is in the unlocked state, the first connector 16 can slide forward and backward without being separated from the box body 13. It is to be understood that when the user needs to access the item in the first type of storage box 10, the user only needs to pull out the first connector 16 to expose the accommodation cavity 11, and then the user can take the item out of the accommodation cavity 11 or store the item in the accommodation cavity 11. When the user does not need to use the first type of storage box 10, the user only needs to push the first connector 16 into the accommodation cavity 11.

The first type of storage box 10 includes track assemblies 161. The first connector 16 slides in the box body 13 under the guidance of the track assemblies 161. Two groups of track assemblies 161 are provided on two sides of the first connector 16, respectively. The structures of the track assemblies 161 on two sides are basically the same. The track assembly 161 includes a first guide member 164 and a second guide member 165. The first guide member 164 is fixedly connected to the box body 13, and the second guide member 165 is fixed to one side of the box body 13. The second guide member 165 is partially engaged in the first guide member 164, and the second guide member 165 is configured to slide relative to the first guide member 164. The box body 13 may be connected to multiple first connectors 16 of different dimensions, that is, multiple first guide members 164 are disposed in the accommodation cavity 11 so that the second guide members 165 on the first connectors 16 of different heights can mate with the first guide members 164. It is to be understood that the user can choose the first connector 16 that is suitable for the dimension of the opening 15, or the user can choose two first connectors 16. In this manner, it is convenient for the user to select the first connectors 16 of different dimensions according to different requirements. Of course, as another example, multiple openings 15 may be provided on the first type of storage box 10, and each of the multiple openings 15 is provided with an adaptive first connector 16.

The first connector 16 may be in the shape of an open box, and the first connector 16 forms a storage space 166. The user may place the item into the storage space 166 and then push the first connector 16 into the accommodation cavity 11, thereby storing the item in the accommodation cavity 11. The toolbox system 100 further includes partition plates 167 that can be detachably mounted in the first connector 16, thereby dividing the first connector 16 into multiple small storage spaces 166, which is convenient for classified storage.

The connection assembly 19 includes a first stopper 191, a second stopper 192, biasing members 193, and a locking member 194. The locking member 194 and the box body 13 are fixedly connected or integrally formed. The locking member 194 and the second stopper 192 can mate with each other so that the first connector 16 and the box body 13 remain fixed relative to each other. The biasing members 193 are disposed between the second stopper 192 and the first stopper 191 and always apply downward biasing forces to the second stopper 192. The first stopper 191 and the first connector 16 are fixedly connected or integrally formed. A locking portion 195 is formed on the locking member 194, and an engagement portion 196 is disposed on the second stopper 192. When the locking portion 195 mates with the engagement portion 196, the first connector 16 is in the locked state, and when the locking portion 195 is separated from the engagement portion 196, the first connector 16 is in the unlocked state. In this example, the first stopper 191 and the first connector 16 are integrally formed. That is, the first connector 16 forms the accommodation cavity 11, the biasing members 193 are disposed in the accommodation cavity 11, the second stopper 192 is at least partially disposed in the accommodation cavity 11 and can synchronously move along with the first stopper 191, an end of the biasing member 193 abuts against the first connector 16, and the other end of the biasing member 193 abuts against the second stopper 192. The biasing members 193 are given the preload during installation so that the biasing members 193 always apply the downward biasing forces to the second stopper 192. The biasing forces cause the locking portion 195 and the engagement portion 196 to always keep mating with each other when the first connector 16 is in the locked state.

The locking portion 195 is disposed on the movement path of the engagement portion 196, the locking portion 195 may be a groove or a hole, the engagement portion 196 is a downward protrusion on the second stopper 192, and the biasing forces applied to the second stopper 192 by the biasing members 193 cause the protrusion to always keep engaged in the hole without being affected by an external force. When the first connector 16 is in the locked state, the protrusion is engaged in the hole. When the first connector 16 needs to be unlocked, the user only needs to apply an upward force to the second stopper 192 to overcome the biasing forces so that the protrusion is separated from the hole, and the first connector 16 can slide out of the box body 13. When the user needs to lock the first connector 16, the user only needs to push the first connector 16 into the box body 13, and the biasing members 193 apply the biasing forces to the second stopper 192 until the protrusion is engaged in the hole so that the first connector 16 and the box body 13 remain fixed relative to each other. In this example, two biasing members 193 may be provided.

The first type of storage box 10 further includes a locking plate 162 and a coupling member 163. The locking plate 162 is used for preventing the first connector 16 from sliding out of the box body 13. The coupling member 163 is used for connecting the box body 13 to the locking plate 162. The locking plate 162 is disposed on the front side of the first type of storage box 10, and the locking plate 162 passes through all the first connectors 16 of the first type of storage box 10. Specifically, two hollow protrusions are formed on the upper top wall 131 of the first type of storage box 10, the two hollow portions are a first protrusion 151 and a second protrusion 152, the first protrusion 151 and the second protrusion 152 are spaced apart, and the locking plate 162 can be inserted into the first protrusion 151 and the second protrusion 152.

Along the up and down direction, the first protrusion 151 and the second protrusion 152 are disposed on two sides of all the first connectors 16 of the first type of storage box 10, and the locking plate 162 is in the shape of a long strip. In this manner, after the locking plate 162 is inserted into the first protrusion 151 and the second protrusion 152, the locking plate 162 can better prevent the first connector 16 from sliding out of the box body 13, thereby ensuring the stability of the connection between the first connector 16 and the box body 13.

The locking plate 162 includes a long strip portion 168 and a bent portion 169 that are fixedly connected or integrally formed. The long strip portion 168 and the bent portion 169 are arranged at an angle. Specifically, the long strip portion 168 and the bent portion 169 are arranged at a right angle. The locking plate 162 is inserted downward into the first protrusion 151 and the second protrusion 152 until the bent portion 169 is in contact with the first protrusion 151, and the locking plate 162 stops moving downward. Corresponding locking holes 153 are formed on the first protrusion 151 and the bent portion 169. The user may use the coupling member 163 to lock the locking plate 162 and the box body 13, thereby further ensuring the stability of the connection between the first connector 16 and the box body 13 and preventing theft. In this example, the coupling member 163 may be a padlock.

As another example, the first connector 16 can rotate relative to the box body 13, and the first connector 16 is pivotally connected to the box body 13, that is, the first connector 16 can be flipped to a vertical position relative to the box body 13. In this case, the user pushes the first connector 16 to store the first connector 16 in the accommodation cavity 11 of the box body 13. In this case, the opening 15 of the box body 13 is in the open state, and the user can place the item in the accommodation cavity 11 or take the item out of the accommodation cavity 11 according to requirements. When the user needs to close the opening 15, the user only needs to pull the first connector 16 out of the accommodation cavity 11 and flip the first connector 16 over until the first connector 16 is locked with the box body 13. In this case, the opening 15 is in the closed state.

As another example, multiple openings 15 are formed on the box body 13, that is, the first type of storage box 10 includes multiple connectors that mate with the openings 15 so that the user can place items in different openings 15 according to requirements.

The toolbox system 100 further includes the interlocking assembly 12 disposed on the upper side of the first type of storage box 10. The toolbox system 100 further includes multiple storage boxes, which are defined herein as second type of storage boxes 20 for ease of description. The second type of storage box 20 may be connected to the upper side of the first type of storage box 10 via the interlocking assembly 12. Specifically, the interlocking assembly 12 includes two symmetrically arranged mounting assemblies 121. The structures of the two mounting assemblies 121 are basically the same. The mounting assemblies 121 are disposed on two sides of the upper top wall 131. The mounting assembly 121 includes a resilient clamping member 122 and a positioning member 123. The clamping member 122 is connected to the upper top wall 131 of the first type of storage box 10, and the positioning member 123 is connected to the lower bottom wall 132 of the second type of storage box 20. When the user needs to connect the second type of storage box 20 to the first type of storage box 10, the second type of storage box 20 is placed downward to lock the clamping members 122 and the positioning members 123, thereby connecting the first type of storage box 10 to the second type of storage box 20. When the user needs to detach the second type of storage box 20 from the first type of storage box 10, the user removes the second type of storage box 20 from the first type of storage box 10 by just pushing the clamping members 122 outward to separate the clamping members 122 from the positioning members 123. In this manner, a third type of storage box 30 may be connected to the upper top wall 131 of the first type of storage box 10 via the mounting assemblies 121, a fourth type of storage box may also be connected to the upper top wall 131 of the third type of storage box 30 via the mounting assemblies 121, and the user may connect more storage boxes to the fourth type of storage box. It is to be noted that, unless otherwise specified, in the present application, the first type of storage box 10, the second type of storage box 20, the third type of storage box 30, and the fourth type of storage box are merely used for distinguishing between different types of storage boxes, and whether the storage boxes are structurally inconsistent is not limited. In other words, the first type of storage box 10, the second type of storage box 20, the third type of storage box 30, and the fourth type of storage box may be the same storage boxes, storage boxes with some consistent structures, or storage boxes with completely different structures. In this example, only a feasible interlocking assembly 12 is introduced. The interlocking assembly 12 may be an interference structure, that is, the lower bottom wall 132 of the second type of storage box 20 has a protruding structure, and the upper top wall 131 of the first type of storage box is formed with a groove for the protruding structure to be inserted into. The specific structure of the interlocking assembly 12 is not limited here, as long as the second type of storage box 20 can be connected to the first type of storage box 10 and the structure can also enable the third type of storage box 30 to be connected to the upper side of the second type of storage box 20.

As another example, the structures of the two mounting assemblies of the interlocking assembly 12 may be inconsistent. One mounting assembly 121 includes a resilient clamping member 122 and a positioning member 123, and the other mounting assembly 124 includes a rotatable stopper 125 and an abutment member 126. The stopper 125 is connected to the upper top wall 131 of the first type of storage box 10, and the abutment member 126 is connected to the item that needs to be mounted on the first type of storage box 10. The item may be a storage box, a blowing device, a refrigeration device, a tool, an accessory, or the like. In this example, the case where the item is the blowing device 127 is used as an example for description. The abutment member 126 is connected to the blowing device 127. When the user needs to connect the blowing device 127 to the first type of storage box 10, the stopper 125 is flipped out from the upper top wall 131, and then the abutment member 126 on the blowing device 127 abuts against the stopper 125; the other side of the blowing device 127 is placed downward so that the positioning member 123 of the blowing device 127 is locked with the clamping member 122 on the first type of storage box 10, thereby locking the blowing device 127 to the first type of storage box 10. When the user needs to remove the blowing device 127, the user only needs to push the clamping member 122 outward to separate the clamping member 122 from the positioning member 123, and then the blowing device 127 can be removed. After the blowing device 127 is removed, the user flips the stopper 125 over to accommodate the stopper 125 on the upper top wall 131. To increase user options, two types of mounting assemblies may be disposed on the upper top wall 131 (as shown in FIG. 1) so that the user can select the mounting assemblies according to requirements to connect other items to the first type of storage box 10.

The toolbox system 100 further includes an external hanger assembly 17 for connecting the item to the storage box. The external hanger assembly 17 may be connected to the sidewall of the storage box or connected to the connection section 138 of the storage box. The external hanger assembly 17 includes an intermediate piece 171 and an external hanger 172. One or more intermediate pieces 171 and external hangers 172 may be provided. One intermediate piece 171 may be mounted on the connection section 138, or more intermediate pieces 171 may be mounted on the connection section 138 along the up and down direction. The intermediate piece 171 is connected to the connection section 138 through one or a combination of screws, pins, rivets, adsorption, interference fit, and movable buckles. In this example, the intermediate piece 171 is mounted to the connection section 138 through a screw connection, that is, the intermediate piece 171 is fixed to the connection section 138 by screws. One or more external hangers 172 may be mounted on the intermediate piece 171, and the external hangers 172 may be connected to the intermediate piece 171 through one or a combination of screws, pins, rivets, adsorption, interference fit, and movable buckles. The external hanger 172 may be one or a combination of a battery pack hanger, a cable hanger, a scale hanger, a support member, a tool accessory box hanger, and a power tool hanger. Of course, as another example, the external hanger 172 may be connected to the sidewall of the storage box through one or a combination of screws, pins, rivets, adsorption, interference fit, and movable buckles. In this manner, the user can connect more items to the storage box. A guard rod is embedded in the connection section 138 and is made of metal material.

Along the up and down direction, the traveling assembly 14 is at least partially disposed on the lower side of the box body 13, and the user can push and pull the box body 13 through the traveling assembly 14. The traveling assembly 14 includes at least one wheel 141. FIGS. 1 to 7 show structural views of the toolbox system 100 in the first example. In this example, the traveling assembly 14 includes two wheels 141, and the two wheels 141 are disposed on the left side of the box body 13. The first handle 181 and the wheels 141 are disposed on the same side of the box body 13. As a specific example, the handle assembly 18 includes a guide frame 182 and the first handle 181. The first handle 181 is movable within the guide frame 182. During the movement of the first handle 181 in the guide frame 182, at least three states exist. When the first handle 181 is in a first state, the first handle 181 is in a retracted state, that is, most of the first handle 181 is accommodated in the guide frame 182 at this time. When the first handle 181 is in a second state, the first handle 181 is in an extended state. At this time, most of the first handle 181 is extended out of the guide frame 182, and the user can hold the first handle 181 to drive the traveling assembly 14. When the first handle 181 is in a third state, the first handle 181 is completely separated from the guide frame 182, that is, the guide frame 182 and the first handle 181 are two parts at this time.

The wheels 141 are connected to the rear sidewall of the box body 13. The first type of storage box 10 has a distance in the length direction. When the distance is less than or equal to 700 mm, the opening 15 is disposed on the front sidewall 135. In this example, the length direction is parallel to the left and right direction. In this manner, the user can directly open the first connector 16 on the front sidewall 135 and then can store and take out the item in the accommodation cavity 11, which is convenient for user operation.

As a specific example, the first type of storage box 10 includes two first connectors 16 that are basically arranged along the up and down direction, which is convenient for the user to classify and manage items. In addition, the first connector 16 can move relative to the box body, and no interference exists between the first connector 16 and the wheels 141 during the movement of the first connector 16.

When the first type of storage box 10 is actually in use, the user may connect the second type of storage box 20 to the first type of storage box 10 through the interlocking assembly 12 so that the user can adjust the first handle 181 to the second state and then hold the first handle 181 to drive the wheels 141 to rotate, thereby driving the first type of storage box 10 and the second type of storage box 20 connected to the first type of storage box 10 to move together. In this example, the first type of storage box 10 is roughly cube-shaped, and the traveling assembly 14 is connected to the lower end of the first type of storage box 10, an abutment portion 137 is disposed at the lower end of the box body 13, and the abutment portion 137 can mate with the wheels 141 so that the first type of storage box 10 can remain standing. When the first type of storage box 10 is stationary as shown in FIG. 1, at least three contact points exist when the box body 13 of the first type of storage box 10 and the wheels 141 are in contact with the ground. The plane where the contact points are located is defined as a support plane P, and the distance L from the support plane P to the guide frame 182 along a direction perpendicular to the support plane P is greater than 0 mm and less than or equal to 550 mm. Under common working conditions, the user uses a pickup truck to transport the toolbox system 100. Among all storage boxes, the structure of the handle assembly 18 of the first type of storage box 10 in the up and down direction needs to be considered relative to storage boxes of other structures. Therefore, the design of the dimension of the first type of storage box 10 in the height direction is particularly important. The first handle 181 is configured to be separated from the guide frame 182 so that the dimension of the box body 13 in the length direction can be as large as possible, thereby ensuring that the accommodation cavity 11 of the first type of storage box 10 can accommodate more items and making the structure design of the storage box more reasonable. Furthermore, the distance from the support plane P to the guide frame 182 is set within the preceding range. When the user needs to move the first type of storage box 10, the first handle 181 may be pulled out from the guide frame 182, and then the first type of storage box 10 can be placed in the pickup truck.

In this example, along the front and rear direction, the opening 15 is disposed on the front side, and the handle assembly 18 and the traveling assembly 14 are disposed on the rear side, which is convenient for the user to push and pull the first connector 16.

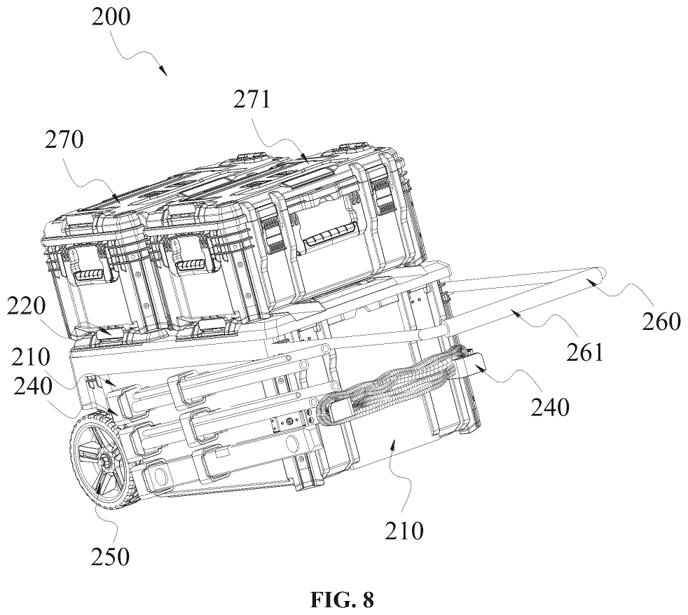

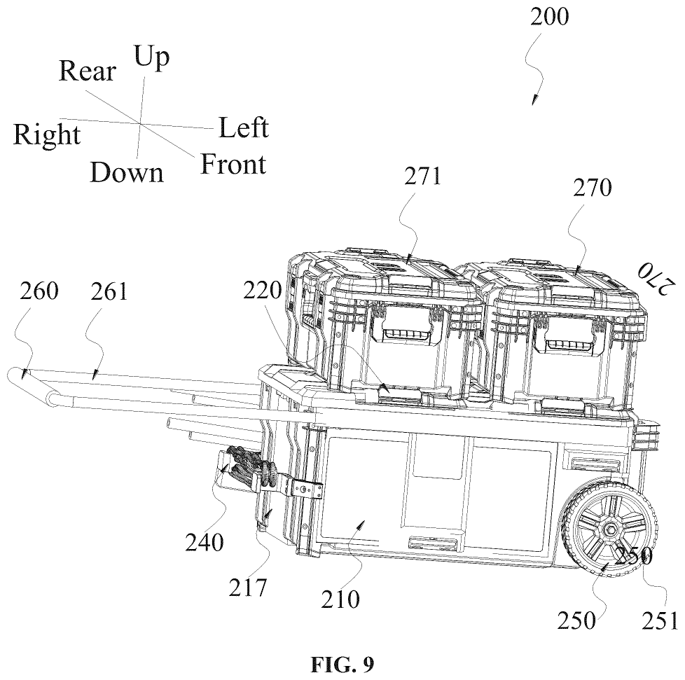

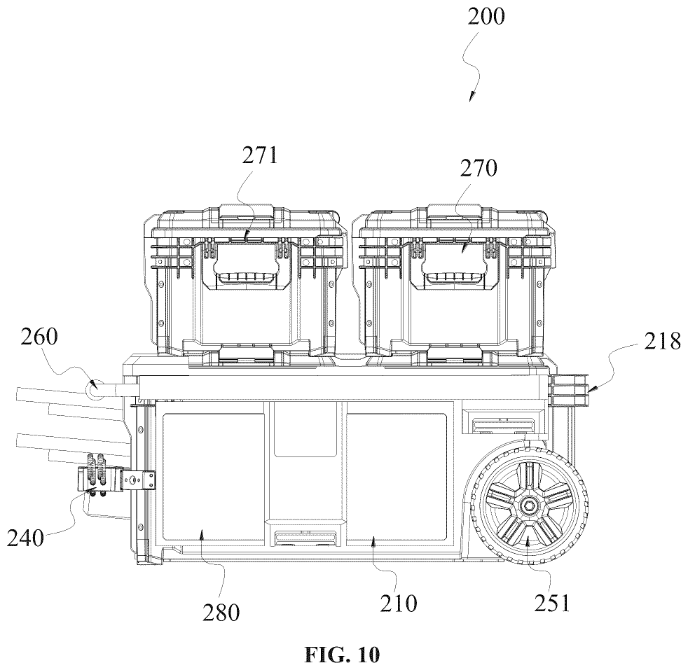

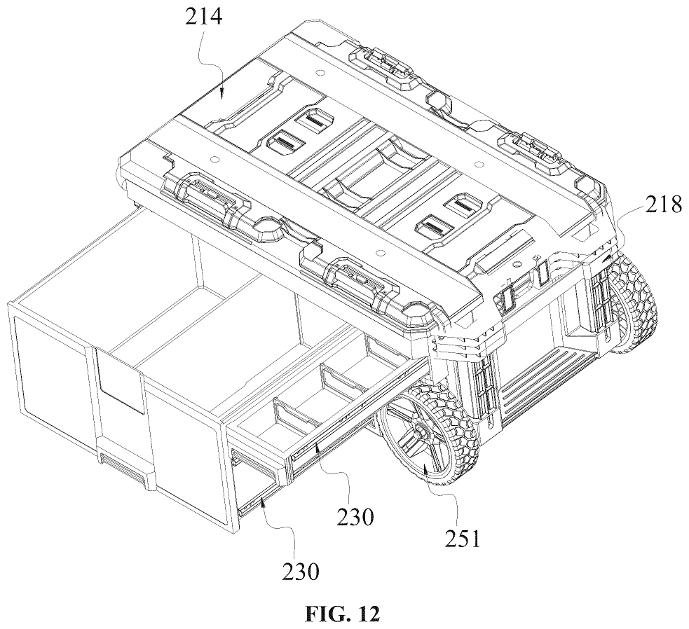

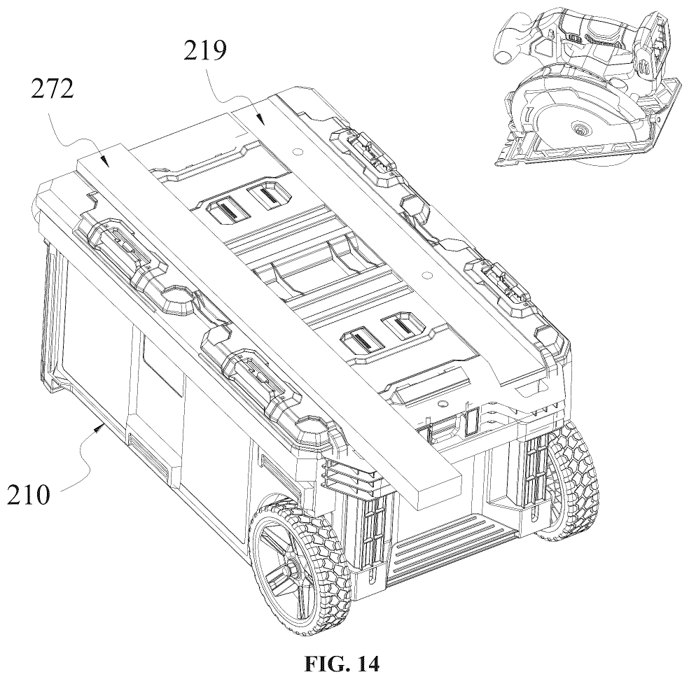

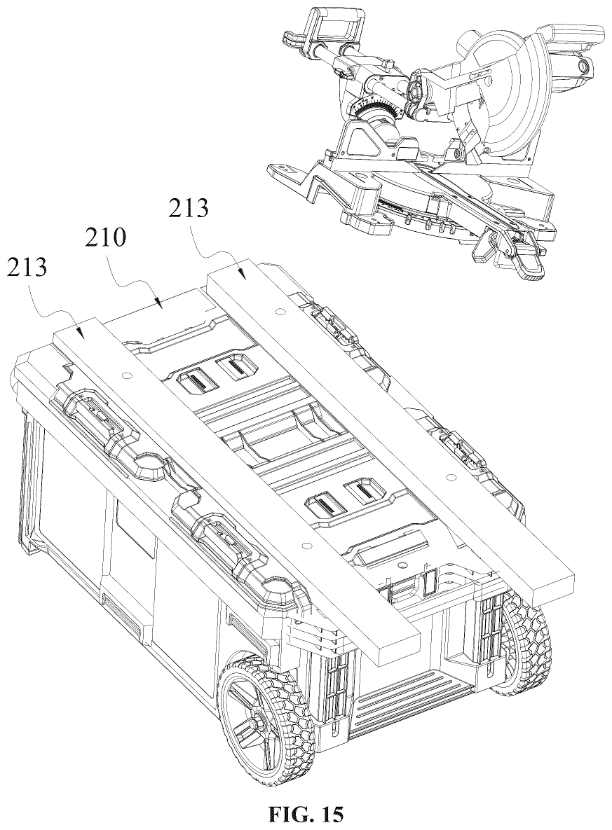

FIGS. 8 to 15 show structural diagrams of a toolbox system 200 in the second example. The structures and principles of an interlocking assembly 220, a guide rail assembly 230, and an external hanger assembly 240 in this example are basically the same as those in the first example. The differences lie in the specific structures of a box body 211, a handle assembly 260, and a traveling assembly 250 of a first type of storage box 210. That is to say, the parts of the first example that are compatible with this example can be applied to this example. The following only introduces the differences between this example and the first example.

As shown in FIGS. 8 to 10, the traveling assembly 250 includes two wheels 251, the two wheels 251 are both disposed on the left side of the box body 211, the wheels 251 rotate about a first axis of rotation, and the exposing direction of the opening of the first type of storage box 210 is basically parallel to the direction of the first axis of rotation. The first type of storage box 210 further includes the handle assembly 260, the handle assembly 260 includes a first handle 261, and the first handle 261 is slidably connected to the box body 211, that is, the first handle 261 has a first state and a second state relative to the box body 211. When the first handle 261 is in the first state, the first handle 261 is in a retracted state, that is, most of the first handle 261 is accommodated in the box body 211 at this time. When the first handle 261 is in the second state, the first handle 261 is in an extended state, that is, most of the first handle 261 is extended out of the box body 211 at this time, and the first handle 261 is connected to the box body 211. When the first type of storage box 210 is actually in use, the user may connect a second type of storage box 270 to the first type of storage box 210 so that the user can adjust the first handle 261 to the second state and then hold the first handle 261 to drive the wheels 251 to rotate, thereby driving the first type of storage box 210 and the second type of storage box 270 connected to the first type of storage box 210 to move together.

The wheels 251 are disposed on the rear sidewall of the box body. The first type of storage box 210 has a distance L3 in the length direction. When the distance L3 is greater than 700 mm, the opening is disposed on the front sidewall. In this manner, the user can still open the first type of storage box 210 when the first type of storage box 210 is connected to the second type of storage box 270.

The first type of storage box 210 has two first connectors 280. The first connectors 280 are arranged side by side along the left and right direction, and no interference exists between the two first connectors 280. The first connector 280 is formed with a recess so that no interference exists between the first connector 280 and the wheels 251 on the movement path of the first connector 280.

In this example, at least two interlocking assemblies 220 are provided on an upper top wall 214 of the first type of storage box 210. In this manner, the user can mount at least two other storage boxes on the first type of storage box 210, that is to say, the second type of storage box 270 and a third type of storage box 271 can be mounted side by side on the upper top wall 214 of the first type of storage box 210 through the interlocking assemblies 220. In this manner, the user drives the wheels 251 by holding the first handle 261, thereby driving the first type of storage box 210 and the second type of storage box 270 connected to the first type of storage box 210 to move together. Of course, the user may connect other storage boxes to the second type of storage box 270 and the third type of storage box 271 so that the user can drive more storage boxes together when moving the first type of storage box 210. Moreover, the user may connect other items to the first type of storage box 210 through the interlocking assemblies 220, such as a heating device, a refrigeration device, a blowing device, or a tool.

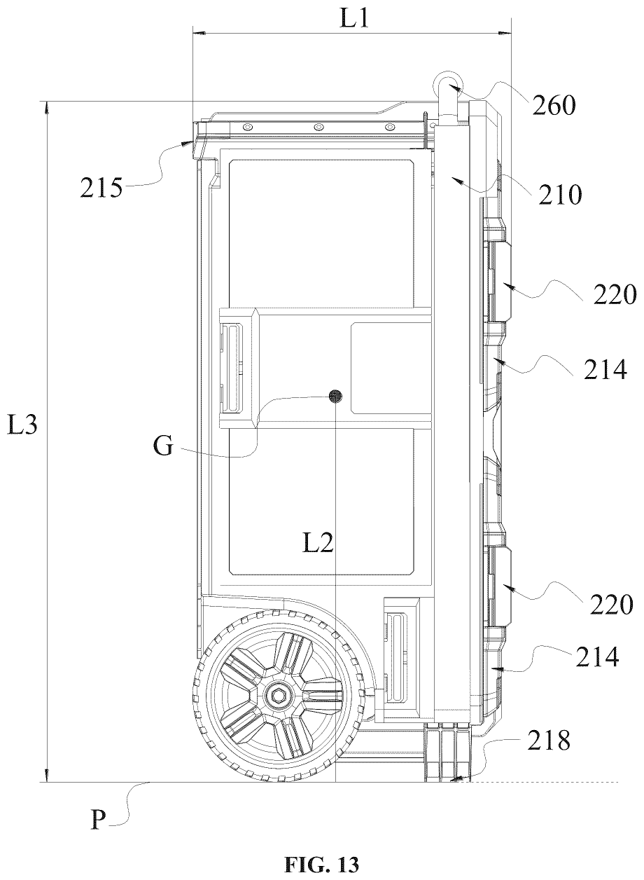

As shown in FIG. 13, the distance L1 from the upper top wall 214 to a lower bottom wall 215 of the first type of storage box 210 along the up and down direction is less than or equal to 450 mm, and the distance L3 from a left sidewall 216 to a right sidewall 217 of the first type of storage box 210 along the left and right direction is greater than 450 mm. It may also be understood as that the dimension of the first type of storage box 210 in the length direction is greater than the dimension of the first type of storage box 210 in the height direction. The toolbox system 200 is carried from the tool storage site to the workplace. The distance between the tool storage site and the workplace is often relatively far. The user needs to use a vehicle to transport the toolbox system 200 to the workplace. Due to the height limit of some vehicles, the first type of storage box 210 cannot be placed directly in the vehicle. By setting the dimension of the first type of storage box 210 in the height direction within the preceding range, the first type of storage box 210 can be directly carried into the vehicle, which is convenient for the user to transport.

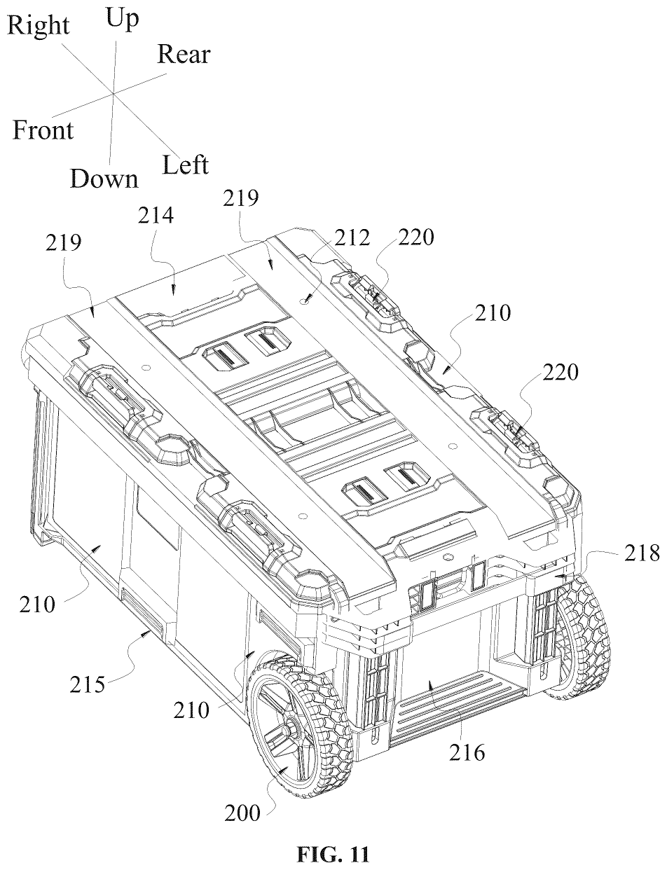

The first type of storage box 210 further includes an abutment portion 218 that can mate with the wheels 251. When the first type of storage box 210 is placed as shown in FIG. 13, at least part of the abutment portion 218 and at least part of the wheels 251 can be in contact with the ground at the same time. At least three contact points exist when the wheels 251 and the abutment portion 218 are in contact with the ground. The plane where the contact points are located is defined as the support plane P. When the wheels 251 and the abutment portion 218 are in contact with the ground, a first connection line L2 between the center of gravity G of the first type of storage box 210 and the ground is basically perpendicular to the support plane P. The dimension of the first type of storage box 210 in the length direction is greater than the dimension of the first type of storage box 210 in the height direction. That is to say, when the first type of storage box 210 is placed in the tool storage site as shown in FIG. 11, the first type of storage box 210 inevitably occupies a large space. The abutment portion 218 is provided, and the abutment portion 218 mates with the wheels 251 so that when the first type of storage box 210 is placed as shown in FIG. 13, the first type of storage box 210 can remain standing. In this manner, the user places the first type of storage box 210 in the tool storage site, thereby effectively and reasonably utilizing the storage space of the tool storage site. It is to be noted that the center of gravity G of the first type of storage box 210 refers to the center of gravity G when no other items are connected to the first type of storage box 210.

Further, positioning grooves 219 are disposed on the upper top wall 214 of the first type of storage box 210. In actual use, the upper top wall 214 of the first type of storage box 210 may be used as a workbench. Specifically, multiple positioning holes 212 are disposed on the positioning groove 219. The user uses screws to penetrate a table saw and support members 213 to lock the table saw on the upper top wall 214 so that the user can use the table saw directly on the upper top wall 214. The support member 213 may be engaged in the positioning groove 219, thereby supporting the table saw. Of course, the solution is applicable to other table tools. The user may clamp a workpiece to be cut in the positioning groove 219 and then use other cutting tools to cut the workpiece 272 to be cut.

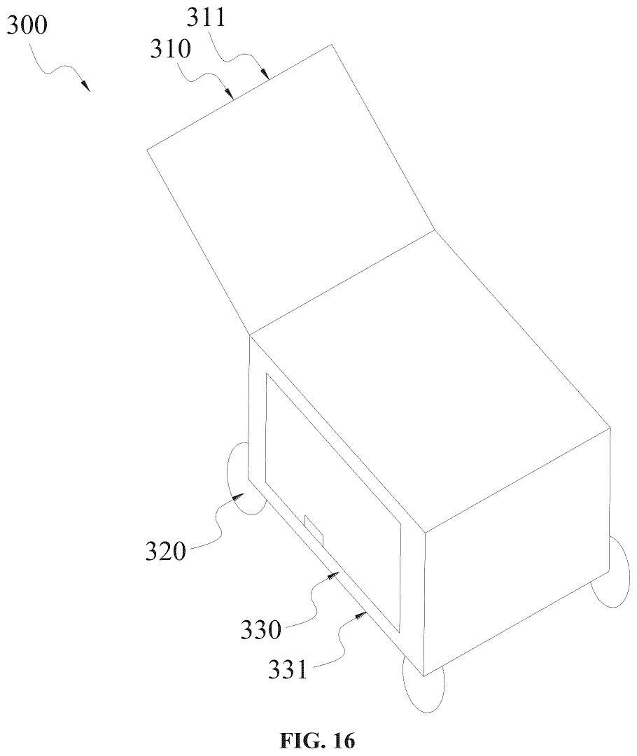

FIG. 16 shows a structural view of a toolbox system 300 in the third example. The principle of this example may be basically the same as that of the first example or the second example. The differences lie in the structures of a handle assembly 310 and a traveling assembly 320. That is to say, the parts of the first example or the second example that are compatible with this example may all be applied to this example. The following only introduces the differences between this example and the first example.

As shown in FIG. 16, as an example, the traveling assembly 320 has four wheels, and the four wheels are disposed around a lower bottom wall 331 of a box body 330. The handle assembly 310 is connected to the box body 330. The handle assembly 310 includes a first handle 311. The first handle 311 is connected to the box body 330. The first handle 311 and the box body 330 may be rotatably connected or slidably connected. The first handle 311 and the box body 330 may be connected in a stepless rotation manner.

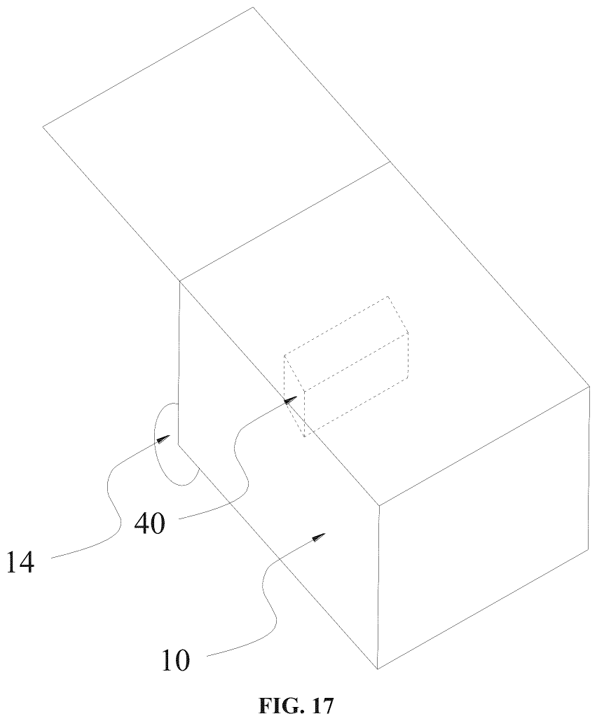

As a feasible example, as shown in FIG. 17, the toolbox system 100 further includes a driving device 40 connected to the first type of storage box 10. The driving device 40 can drive the traveling assembly 14 to move or stop. When the driving device 40 drives the traveling assembly 14 to move, the user does not need a lot of strength when pushing and pulling the first type of storage box 10 and only needs to control the forward direction of the first type of storage box 10. The driving device 40 may be a motor with a power supply. The driving device 40 may be a wheel hub motor.

The basic principles, main features, and advantages of the present application are shown and described above. It is to be understood by those skilled in the art that the preceding examples do not limit the present application in any form, and any technical solutions obtained through equivalent substitutions or equivalent transformations are within the scope of the present application.

What is claimed is:

1. A toolbox system, comprising:
a first storage box comprising a box body having an accommodation cavity and an opening formed on a sidewall of the box body that leads to the accommodation cavity, a traveling assembly, having at least one wheel, connected to the box body, and at least one first connector coupled to the box body and moveable relative to the opening between a first position that blocks the opening and a second position that unblocks the opening;
a second storage box; and
at least one interlocking assembly that connects the second storage box to the first storage box.

2. The toolbox system of claim 1, further comprising a third storage box and two interlocking assemblies disposed on an upper top wall of the box body of the first storage box, the two interlocking assemblies connecting the first storage box to both the second storage box and the third type storage box with the second storage box and the third storage box being in side by side relation.

3. The toolbox system of claim 2, wherein a distance L1 from the upper top wall of the box body to a lower bottom wall of the box body, opposite the upper top wall, is less than or equal to 450 mm.

4. The toolbox system of claim 1, wherein the first storage box has an abutment portion, at least a part of the abutment portion and at least part of the at least one wheel are arranged to contact with the ground at the same time, at least three contact points exist when the at least one wheel and the abutment portion are in contact with the ground, a plane where the at least three contact points are located is defined as a support plane P; and, when the at least one wheel and the abutment portion are in contact with the ground, a first connection line L2 between a center of gravity G of the first storage box and the ground is substantially perpendicular to the support plane P.

5. The toolbox system of claim 1, wherein the first storage box is provided with connection sections and the toolbox system further comprises an external hanger assembly, the external hanger assembly comprises an intermediate piece and an external hanger, the intermediate piece is connect to a connection section of the connection sections through one or a combination of screws, pins, rivets, and movable buckles, and the external hanger is connectable to the intermediate piece and/or the connection section through one or a combination of screws, pins, rivets, and movable buckles.

6. The toolbox system of claim 1, further comprising an external hanger for detachably connecting an item and wherein a mounting portion is formed on a sidewall of the box body and the external hanger is connected to the mounting portion through one or a combination of screws, pins, rivets, adsorption, and movable buckles.

7. The toolbox system of claim 1, wherein the box body has a front sidewall, a rear sidewall, a left sidewall, a right sidewall, a lower bottom wall, and an upper top wall, each of the front sidewall, the rear sidewall, the left sidewall, the right sidewall extends substantially along an up and down direction, the lower bottom wall and the upper top wall are opposite to each other, the front sidewall, the rear sidewall, the left sidewall, the right sidewall, the lower bottom wall, and the upper top wall form a substantially enclosed space, at least one track assembly is disposed in the accommodation cavity, each of the at least one track assembly is provided with an adaptive first connector of the at least one first connector, and the at least one first connector is slidably connected to the box body through the at least one track assembly.

8. The toolbox system of claim 7, wherein the toolbox system further comprises a handle assembly, the handle assembly has a grip, the grip and the at least one wheel are disposed at two ends of the box body, and the at least one first connector is disposed on a sidewall between the grip and the box body.

9. The toolbox system of claim 7, wherein the toolbox system further comprises a handle assembly, the handle assembly has a grip, the grip and the at least one wheel are disposed on a same side of the box body, and the at least one first connector is disposed on a sidewall opposite to the at least one wheel.

10. The toolbox system of claim 7, wherein the first storage box comprises at least two correspondingly arranged track assemblies, each of the at least two track assemblies comprises a first guide member and a second guide member that mate with each other, the first guide member is connected to the box body, the second guide member is connected to a first connector of the at least one first connector, the second guide member is partially engaged in the first guide member, and the second guide member slides relative to the first guide member.

11. The toolbox system of claim 1, wherein the box body comprises a front sidewall, a rear sidewall, a left sidewall, a right sidewall, a lower bottom wall, and an upper top wall, each of the front sidewall, the rear sidewall, the left sidewall, and the right sidewall extends substantially along an up and down direction, the lower bottom wall and the upper top wall are opposite to each other, the front sidewall, the rear sidewall, the left sidewall, the right sidewall, the lower bottom wall, and the upper top wall form a substantially enclosed space, at least one track assembly is disposed in the accommodation cavity, each of the at least one track assembly is provided with an adaptive first connector of the at least one first connector, and the at least one first connector is rotatably connected to the box body through the at least one track assembly.

12. The toolbox system of claim 7, wherein the toolbox system further comprises a locking plate and a coupling member, first and second hollow protrusions are formed on the front sidewall of the first storage box, the first protrusion and the second protrusion are disposed on two sides of the opening, the locking plate passing through the first protrusion and the second protrusion, corresponding locking holes are formed on the locking plate and the first protrusion, and the coupling member passing through the locking holes to connect the locking plate to the first protrusion.

13. The toolbox system of claim 1, wherein the traveling assembly comprises four wheels connected to four sides of the box body, the first storage box further comprises a handle assembly connected to the box body, the handle assembly comprises a first handle, and the first handle is pushed and pulled so that the four wheels are movable relative to the ground and the first storage box and the second storage box are movable together.

14. The toolbox system of claim 1, wherein the first storage box is further provided with a driving device for driving the traveling assembly to move or stop.

15. A toolbox system, comprising:
a first storage box comprising a box body having an accommodation cavity and an opening formed on a sidewall of the box body that leads to the accommodation cavity, a traveling assembly, having at least one wheel, connected to the box body, and at least one first connector coupled to the box body and moveable relative to the opening between a first position that blocks the opening and a second position that unblocks the opening.

16. A toolbox system, comprising:
a first storage box comprising a box body having an accommodation cavity and an opening formed on a sidewall of the box body that leads to the accommodation cavity, a traveling assembly, having at least one wheel and a motor, connected to the box body, and at least one first connector coupled to the box body and moveable relative to the opening between a first position that blocks the opening and a second position that unblocks the opening;
a second storage box; and
at least one interlocking assembly that mounts the second storage box to an upper side of the first storage box.

17. The toolbox system of claim 16, wherein the box body comprises a front sidewall, a rear sidewall, a left sidewall, a right sidewall, a lower bottom wall, and an upper top wall, each of the front sidewall, the rear sidewall, the left sidewall, and the right sidewall extends substantially along an up and down direction, the lower bottom wall and the upper top wall are opposite to each other, the front sidewall, the rear sidewall, the left sidewall, the right sidewall, the lower bottom wall, and the upper top wall form a substantially enclosed space, and the opening is disposed at a lower end of the upper top wall.

18. The toolbox system of claim 17, wherein the traveling assembly comprises wheels connected to the rear sidewall of the box body, the first storage box has a distance in a length direction, and, when the distance is less than or equal to 700 mm, the opening is disposed on the front sidewall.

19. The toolbox system of claim 17, wherein the traveling assembly comprises wheels connected to the right sidewall of the box body, the first type of storage box has a distance in a length direction, and, when the distance is greater than 700 mm, the opening is disposed on the front sidewall.

20. The toolbox system of claim 19, wherein the first storage box further comprises one or more first connectors each formed with a recess so that the one or more first connectors avoid the wheels when moving relative to the box body.
